(19) United States
(12) Patent Application Publication
(10) Pub. No.: US 2010/0136912 A1
(43) Pub. Date: Jun. 3, 2010

(54) Antenna having a defined gap between first and second radiating elements

(75) Inventor: Alireza Hormoz Mohammadian, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/063,368

(22) PCT Filed: Oct. 4, 2007
(86) PCT No.: PCT/US07/80500

§ 371 Date: Feb. 8, 2008

(51) Int. Cl. H04B 7/00; H01Q 1/24; H01Q 1/38

(52) U.S. Cl. 455/41.3; 343/702; 343/700 MS

(57) ABSTRACT

An apparatus including an antenna for wireless communications is disclosed. The apparatus includes a first radiating element and a second radiating element that substantially surrounds the first radiating element to define a gap therebetween. The first radiating element is electromagnetically coupled to an electrically insulated from the second radiating element. The apparatus may further include a third radiating element that is electromagnetically coupled to the first and second radiating element. The third radiating element may be electrically coupled to the second radiating element and electrically insulated from the first radiating element. The second radiating element may include at least one characteristic feature that is substantially the same as at least one characteristic feature of the third radiating element.

### BACKGROUND

1. Field

The present disclosure relates generally to communications systems, and more specifically, to an antenna comprising first and second radiating elements having substantially the same characteristic features.

2. Background

Communications devices that operate on a limited power supply, such as a battery, typically use techniques to provide the intended functionality while consuming relatively small amounts of power. One technique that has been gaining in popularity relates to transmitting signals using pulse modulation techniques. This technique generally involves transmitting information using low duty cycle pulses and operating in a low power mode during times when not transmitting the pulses. Thus, in these devices, the efficiency is typically better than communications devices that operate a transmitter continuously.

Since, in some applications, the pulses may have a relatively small duty cycle, the antenna used for transmitting or receiving the pulses should minimize the effects it has on the shape or frequency content of the pulses. Thus, the antenna should have a relatively large bandwidth. Further, since the antenna may be used in low power applications where a limited power supply, such as a battery, is used, the antenna should have relatively high efficiency in transmitting or receiving signals to and from a wireless medium. Thus, its return loss across the intended bandwidth should be relatively high. Additionally, since the antenna may be used in applications where it needs to be incorporated in a relatively small housing, the antenna should also have a relatively compact configuration.

### SUMMARY

An aspect of the disclosure relates to an apparatus for wireless communications. The apparatus comprises a first radiating element and a second radiating element that substantially surrounds the first radiating element to define a gap therebetween. In another aspect, the first radiating element is electromagnetically coupled to and electrically insulated from the second radiating element.

In another aspect, the apparatus further comprises a third radiating element that is electromagnetically coupled to the first and second radiating element. The third radiating element may be electrically coupled to the second radiating element and electrically insulated from the first radiating element. In yet another aspect, the second radiating element includes at least one characteristic feature that is substantially the same as at least one characteristic feature of the third radiating element.

In another aspect, the at least one characteristic feature of the second radiating element extends substantially perpendicular to at least one characteristic feature of the third radiating element. In yet another aspect, the at least one characteristic feature of the second radiating element extends substantially parallel to at least one characteristic feature of the third radiating element. In still another aspect, the at least one characteristic feature of the second or third radiating element comprises a direction, a length, a width, a height, an area, or a volume.

In another aspect, the apparatus further comprises a dielectric substrate, wherein the first and second radiating elements are formed as metallization layers on one or more sides of the dielectric substrate. In yet another aspect, the dielectric substrate includes one or more chamfered corners.

In another aspect, the apparatus further comprises a feed that is electrically coupled to the first radiating element and electrically insulated from the second radiating element. In yet another aspect, the feed forms part of or is electrically coupled to a center conductor of a coaxial transmission line. In still another aspect of the invention, the feed is electrically coupled to a printed circuit board.

In another aspect, the first and second radiating elements of the apparatus are adapted to transmit or receive a signal within a defined ultra-wide band (UWB) channel that has a fractional bandwidth on the order of 20% or more, has a bandwidth on the order of 500 MHz or more, or has a fractional bandwidth on the order of 20% or more and has a bandwidth on the order of 500 MHz or more.

Other aspects, advantages and novel features of the present disclosure will become apparent from the following detailed description of the disclosure when considered in conjunction with the accompanying drawings.

### BRIEF DESCRIPTION OF THE DRAWINGS

FIGS. 1A-C illustrate front, side, and rear partial cross-sectional views of an antenna in accordance with an aspect of the disclosure.

FIGS. 2A-B illustrate front partial and side cross-sectional views of another exemplary antenna in accordance with another aspect of the disclosure.

FIGS. 3A-B illustrate front and side, partial cross-sectional views of another exemplary antenna in accordance with another aspect of the disclosure.

FIGS. 4A-B illustrate front and side, partial cross-sectional views of another exemplary antenna in accordance with another aspect of the disclosure.

FIG. 5 illustrates a front, partial cross-sectional view of an exemplary antenna coupled to a coaxial transmission line in accordance with another aspect of the disclosure.

FIG. 6 illustrates a front, partial cross-sectional view of an antenna coupled to a printed circuit board in accordance with another aspect of the disclosure.

FIG. 7 illustrates a front, partial cross-sectional view of another exemplary antenna coupled to a printed circuit board in accordance with another aspect of the disclosure.

FIG. 8 illustrates a block diagram of an exemplary communications device in accordance with another aspect of the disclosure.

FIG. 9 illustrates a block diagram of another exemplary communications device in accordance with another aspect of the invention.

FIG. 10 illustrates a block diagram of another exemplary communications device in accordance with another aspect of the invention.

FIGS. 11A-D illustrate timing diagrams of various pulse modulation techniques in accordance with another aspect of the disclosure.

FIG. 12 illustrates a block diagram of various communications devices communicating with each other via various channels in accordance with another aspect of the disclosure.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

As an example of some of the above concepts, in some aspects, the apparatus includes a first radiating element and a second radiating element that substantially surrounds the first radiating element to define a gap therebetween. The first radiating element is electromagnetically coupled to and electrically insulated from the second radiating element. The apparatus may further include a third radiating element that is electromagnetically coupled to the first and second radiating element. The third radiating element may be electrically coupled to the second radiating element and electrically insulated from the first radiating element. The second radiating element may include at least one characteristic feature that is substantially the same as at least one characteristic feature of the third radiating element.

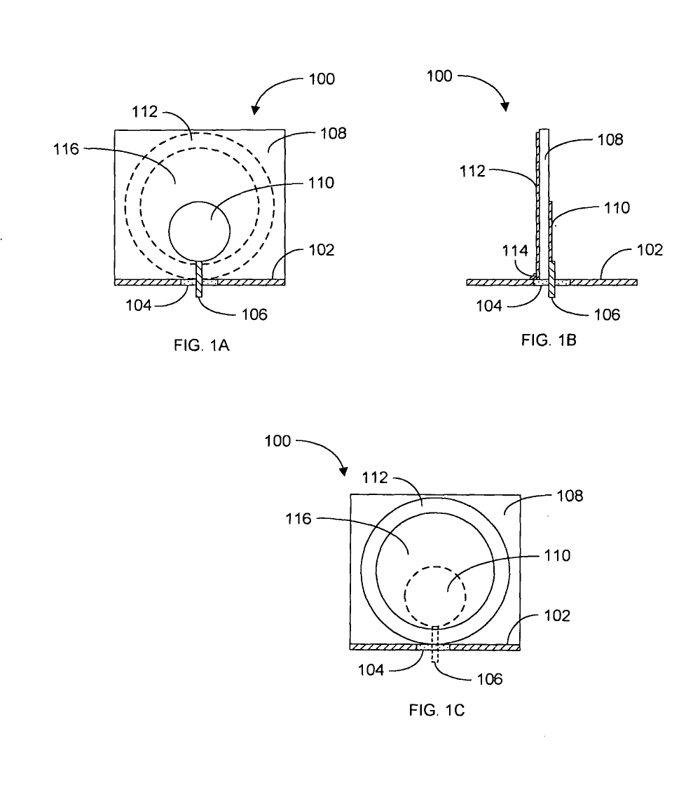

FIGS. 1A-C illustrate front, side, and rear partial cross-sectional views of an antenna 100 in accordance with an aspect of the disclosure. The antenna 100 comprises a dielectric substrate 108, a first radiating element 110 disposed on a front side of the substrate 108, and a second radiating element 1112 disposed on a rear side of the substrate. The antenna 100 further comprises a third radiating element 102, a feed 106, and an electrical insulator 104.

More specifically, the first radiating element 110 may be configured as a metallization layer disposed on the front side of the dielectric substrate 108. The first radiating element 110 may also be configured to have a circular shape. It shall be understood, however, that the first radiating element 110 may have other shapes, such as elliptical, square, rectangular, diamond, or polygon.

The second radiating element 112 may be configured as a metallization layer disposed on the rear side of the dielectric substrate 108. The second radiating element 112 configured to substantially surround the first radiating element 110, although they need not lie exactly on the same plane. In this example, the second radiating element 112 is configured to have a circular ring-shape. It shall be understood that the second radiating element 112 may have different types of ring-shape, such as elliptical ring-shape, square or rectangular ring-shape, diamond ring-shape, or polygon ring shaped.

In this configuration, the first radiating element 110 is electromagnetically coupled to the second radiating element 112. However, the first radiating element 110 is electrically insulated from the second radiating element 112. Also, in this configuration, a gap 116 is defined between the first and second radiating elements 110 and 112.

The third radiating element 102 is electromagnetically coupled to and electrically insulated from the first radiating element 110. The third radiating element 102 is electrically coupled to the second radiating element 112 via an electrical connection 114, which could be a gold ribbon, wirebonds, solder, conductive epoxy, or other type of electrical connection. The third radiating element 102 may be configured as a substantially planar and circular metal plate. However, it shall be understood that the third radiating element 102 may have different shapes. The third radiating element 102 may further be electrically coupled to ground potential.

In this example, the third radiating element 102 includes the electrical insulator 104 to electrically isolate it from the feed 106. The feed 106 may extend from below the third radiating element 102 as shown, through a centralized opening within the electrical insulator 104, and to the first radiating element 110 to make electrical contact thereto. The feed 106 routes signals to the first radiating element 110 for radiating into a wireless medium. The feed 106 routes signals picked up by the first radiating element 110 to other components for processing.

In the antenna 100, the second radiating element 112 includes at least one characteristic feature that is substantially the same as at least one characteristic feature of the third radiating element 102. A characteristic feature of a radiating element includes a spatial parameter that dictates a primary effect on the frequency response of the antenna 100, such as its low frequency roll off, bandwidth, or high frequency roll off. For example, for the case where the second and third radiating elements 112 and 102 are respectively circular ring-shaped and circular, the characteristic feature may include the outer diameter of the ring and the diameter of the circle, respectively. Thus, in this example, the outer diameter of the ring-shaped second first radiating element 112 may be configured substantially the same as the diameter of the circular third radiating element 102.

The orientation of the characteristic feature of the second radiating element 112 may be configured substantially parallel to the characteristic feature of the third radiating element 102. For instance, taking the above example where the second radiating element 112 is configured as an elliptical ring and the third radiating element 102 is configured as a planar circular shape, the elliptical second radiating element 112 may be configured to have its minor axis oriented substantially parallel to the surface of the circular third radiating element 102. In this orientation, the major axis of the elliptical second radiating element 112 is substantially perpendicular to the surface of the circular third radiating element 102.

The orientation of the characteristic feature of the second radiating element 112 may also be configured substantially perpendicular to the characteristic feature of the third radiating element 102. For instance, taking again the above example where the second radiating element 112 has a substantially planar elliptical shape and the third radiating element 102 has substantially a planar circular shape, the elliptical second radiating element 112 may be configured to have its minor axis oriented substantially perpendicular to the surface of the circular third radiating element 102. In this orientation, the major axis of the elliptical first radiating element 112 is substantially parallel to the surface of the circular third radiating element 102.

In some sample aspects, the diameter of the first radiating element 110 may be configured to be approximately 3 mm to 12 mm, the diameter of the second radiating element 112 may be configured to be approximately 10 mm to 15 mm, and the diameter or width of the third radiating element 102 may be configured to be approximately 10 mm to 15 mm. With these parameters, this antenna may operate suitably within the UWB being defined in this disclosure such as between 6 GHz-10 GHz and preferably between 7 GHz-9 GHz.

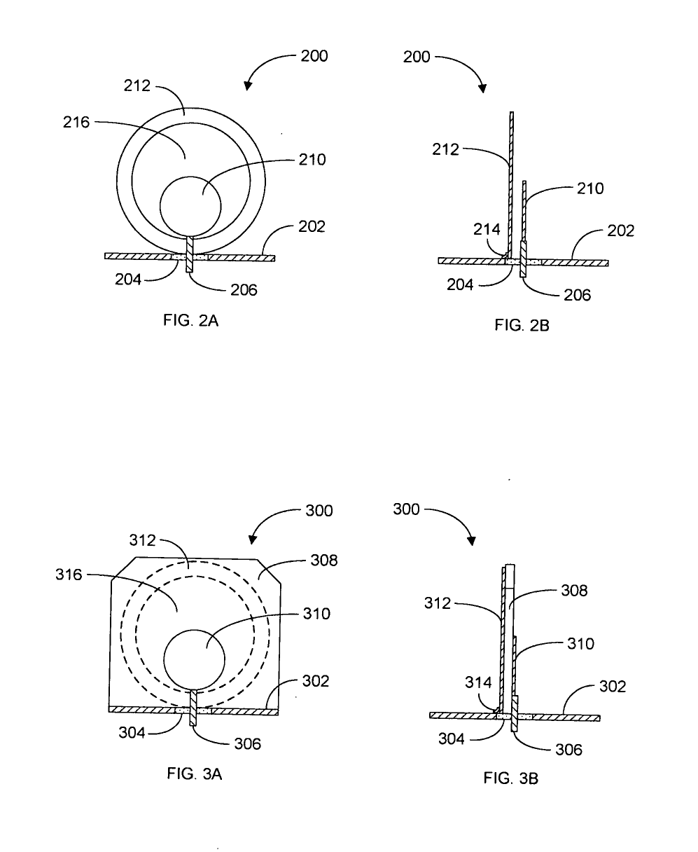

FIGS. 2A-B illustrate front partial and side cross-sectional views of another exemplary antenna 200 in accordance with another aspect of the disclosure. In summary, the antenna 200 is similar to antenna 100, except that it does not include the dielectric substrate 108. In particular, the antenna 200 comprises a first radiating element 210, a second radiating element 212, a third radiating element 202, a feed 206, and an electrical insulator 204. The third radiating elements 202, feed 206, and electrical insulator 204 may be configured substantially the same as the third radiating elements 102, feed 106, and electrical insulator 104 of antenna 100 as previously discussed.

The first and second radiating elements 210 and 212 may also be configured similar to the first and second radiating elements 110 and 112 of antenna 100 previously discussed. However, in this example, the first and second radiating elements 210 and 212 are configured to provide their own support. Thus, an air gap 216 is defined between the first and second radiating elements 210 and 212. In this configuration, the first and second radiating elements 110 and 112 may each be configured as a solid metal structure or a solid dielectric structure that has a metallization layer disposed thereon.

FIGS. 3A-B illustrate front and side, partial cross-sectional views of another exemplary antenna 300 in accordance with another aspect of the disclosure. In summary, the antenna 300 is similar to antenna 100, except that the dielectric substrate has chamfered corners to reduce the area occupied by the antenna 300. In particular, the antenna 300 comprises a dielectric substrate 308, a first radiating element 310, a second radiating element 312, a third radiating element 302, a feed 306, and an electrical insulator 304. These elements may respectively be may be configured substantially the same as the dielectric substrate 108, first radiating element 110, second radiating element 112, third radiating element 102, feed 106, and electrical insulator 104 of antenna 100 as previously discussed. However, as previously discussed, the dielectric substrate 308 includes chamfered corners for compactness purposes.

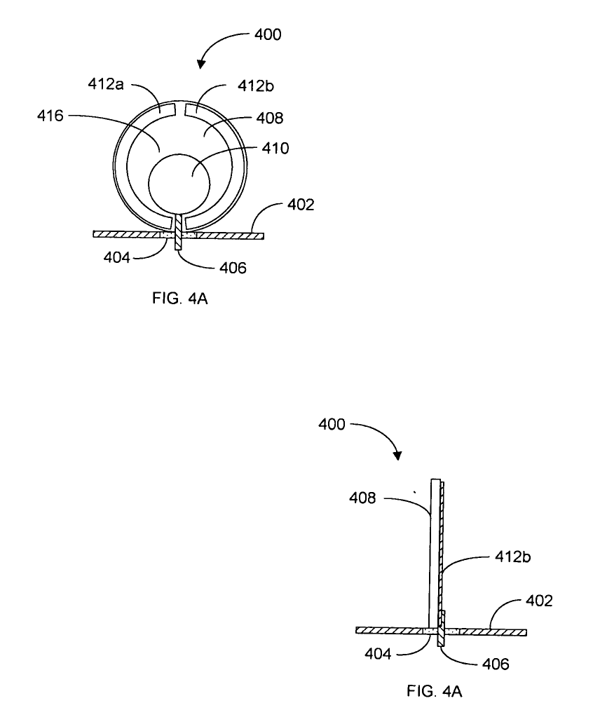

FIGS. 4A-B illustrate front and side, partial cross-sectional views of another exemplary antenna 499 in accordance with another aspect of the disclosure. In summary, the antenna 400 is similar to antenna 100, except that the second radiating element may be configured as two semi-circular metallization traces. This allows the second radiating element to be formed on the side of the dielectric substrate on which the first radiating element is formed.

In particular, the antenna 400 comprises a dielectric substrate 408, first radiating element 410, a second radiating element comprising two metallization traces 412a-b, a third radiating element 402, a feed 406, and an electrical insulator 404. The first and third radiating elements 410 and 402, feed 406, and electrical insulator 404 may be configured substantially the same as the first and third radiating element 110 and 102, feed 106, and electrical insulator 104 of antenna 100 as previously discussed.

However, in this example, the first radiating element includes two almost-semi-circular traces 412a and 412b that, in combination, substantially surrounds the first radiating element 410 to define a gap 416 therebetween. Because the semi-circular trances 412a and 412b are almost semi-circular (e.g., they each have an arc almost but less than 180 degrees), there is a small gap between then near the top of the dielectric substrate 408 and a small gap near the bottom of the dielectric substrate 408. This configuration allows the second radiating element 412a-b to be formed on the same side of the dielectric substrate 408 on which the first radiating element 410 is formed. The small gap between the metallization traces 412a-b near the bottom allows the feed to extend therethrough to make electrical contact to the first radiating element. Although in this example, the first and second radiating elements are formed on the same side of the substrate 408, it shall be understood that the first and second radiating elements may be formed respectively on different sides as in antenna 100.

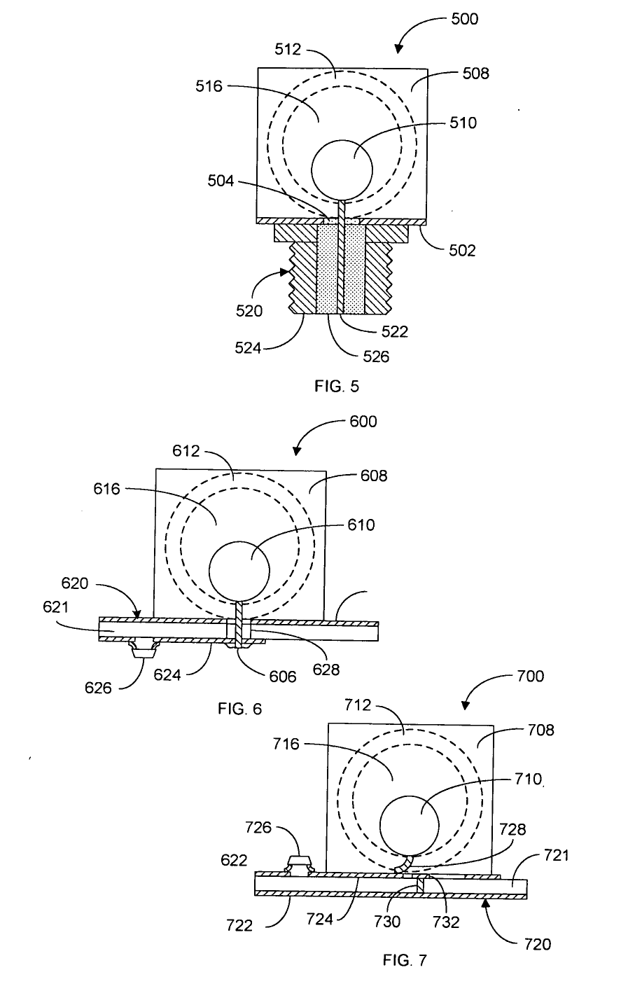

FIG. 5 illustrates a front, partial cross-sectional view of an exemplary antenna 500 coupled to a coaxial transmission line in accordance with another aspect of the disclosure. In summary, the antenna 500 is similar to antenna 100, except that the feed is electrically coupled or part of the central conductor of a coaxial transmission line. In particular, the antenna 500 comprises a dielectric substrate 508, a first radiating element 510, a second radiating element 512, a defined gap between the first and second radiating elements 510 and 512, a third radiating element 502, and an electrical insulator 504. The first, second, and third radiating elements 510, 512 and 502, gap 516, and electrical insulator 504 may be configured substantially the same as the first, second, and third radiating elements 110, 112 and 102, gap 116, and electrical insulator 104 of antenna 100 as previously discussed.

However, in this example, the antenna 500 further includes a coaxial transmission line 520 for routing a signal to or from the first radiating element 518. The coaxial transmission line 520, in turn, comprises an outer electrical conductor 524, a central electrical conductor 522, and a dielectric or electrical insulator 526 disposed between the outer and central conductors 524 and 522. As is customary for coaxial transmission lines, the central conductor 522 may be configured as a substantially circular rod, the dielectric 526 may be configured substantially as a ring surrounding and in contact with the central conductor 522, and the outer conductor 524 may also be configured substantially as a ring surrounding and in contact with the ring-shaped insulator 526. The outer conductor 524 may further include threads for mating with other components that interface with the antenna 500.

As previously mentioned, the central conductor 522 of the coaxial transmission line 520 is electrically coupled to the first radiating element 510. As such, the coaxial transmission line 520 is able to route a signal to the first radiating element 510 for radiation into a wireless medium, and is able to route a signal from the first radiating element 510 to another component. Although in this example, the antenna 500 is configured as the antenna 100 except for the coaxial transmission line 520, it shall be understood that the coaxial transmission line 520 may be configured to interface with any of the antennas described herein.

FIG. 6 illustrates a front, partial cross-sectional view of an antenna 600 coupled to a printed circuit board in accordance with another aspect of the disclosure. In summary, the antenna 600 is similar to antenna 100, except that the feed is electrically coupled to a signal metallization trace of a printed circuit board. In particular, the antenna 600 comprises a dielectric substrate 608, first and second radiating elements 610 and 612, defined gap 616 between the first and second radiating elements 610 and 612, and a feed 606. The dielectric substrate 608, first and second radiating elements 610 and 612, gap 616, and feed 606 may be configured substantially the same as the f dielectric substrate 108, first and second radiating elements 110 and 112, gap 116, and feed 106 of antenna 100 as previously discussed.

However, in this example, the antenna 600 further includes a printed circuit board 620 for routing a signal to or from the first radiating element 610. The printed circuit board 620 may be configured as a microstrip. In particular, the printed circuit board 620 comprises a dielectric substrate 621, a ground metallization plane 622 disposed on an upper side of the substrate 621, and a signal metallization trace 624 disposed on a lower side of the substrate 621. The printed circuit board 620 may further include one or more components, such as component 626, for processing the signal sent to and/or received from the first radiating element 610. In this example, the feed 606 is electrically coupled to the signal metallization trace 624. The feed 606 extends from the signal metallization trace to the first radiating element 610 through a non-plated via hole 628. The feed 606 is electrically insulated from the ground metallization plane 622. In this case, the ground metallization plane 622 operates as the third radiating element which is electromagnetically coupled to and electrically insulated from the first radiating element 610, as well as being electrically coupled to the second radiating element 612. It shall be understood that the printed circuit board 620 may be used to send to and/or receive signals from the first radiating element of any antennas described herein.

FIG. 7 illustrates a front, partial cross-sectional view of another exemplary antenna 700 coupled to a printed circuit board in accordance with another aspect of the disclosure. In summary, the antenna 700 is similar to antenna 600, except that the printed circuit board is flipped up-side-down. In particular, the antenna 700 comprises a dielectric substrate 708, first and second radiating elements 710 and 712, defined gap 716 between the first and second radiating elements 710 and 712, and a feed 706. The dielectric substrate 708, first and second radiating elements 710 and 712, gap 716, and feed 706 may be configured substantially the same as the f dielectric substrate 608, first and second radiating elements 610 and 612, gap 616, and feed 606 of antenna 600 as previously discussed.

However, in this example, the antenna 700 further includes a printed circuit board 720 that includes the signal metallization trace on its upper side and the ground metallization plane on its lower side. In particular, the printed circuit board 720 comprises a dielectric substrate 721, a ground metallization plane 722 disposed on a lower side of the substrate 721, and a signal metallization trace 724 disposed on an upper side of the substrate 721. The printed circuit board 720 may further include one or more components, such as component 726, for processing the signal sent to and/or received from the first radiating element 710. In this example, the feed 706 is electrically coupled to the signal metallization trace 724. In this case, the ground metallization plane 722 operates as the third radiating element which is electromagnetically coupled to and electrically insulated from the first radiating element 710. It shall be understood that the printed circuit board 720 may be used to send and/or receive signals from the first radiating element of any antennas described herein.

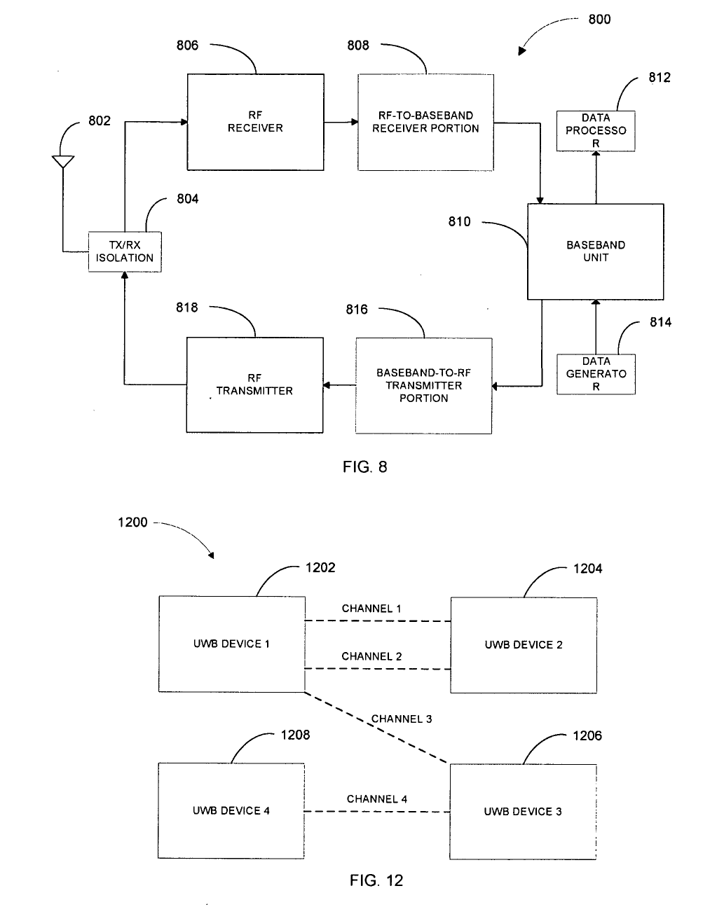

FIG. 8 illustrates a block diagram of an exemplary communications device 800 in accordance with another aspect of the disclosure. The communications device 800 may be particularly suited for sending and receiving data to and from other communications devices. The communications device 800 comprises an antenna 802, a Tx/Rx isolation device 804, a radio frequency (RF) receiver 806, an RF-to-baseband receiver portion 808, a baseband unit 810, a data processor 812, a data generator 814, a baseband-to-RF transmitter portion 816, and an RF transmitter 818. The antenna 802 may be configured as any one of the antennas previously discussed.

In operation, the data processor 812 may receive data from another communications device via the antenna 802 which picks up the RF signal from the communications device, the Tx/Rx isolation device 804 which routes the signal to the RF receiver 806, the RF receiver 806 which amplifies the received signal, the RF-to-baseband receiver portion 808 which converts the RF signal into a baseband signal, and the baseband unit 810 which processes the baseband signal to determine the received data. The data processor 812 may then perform one or more defined operations based on the received data. For example, the data processor 812 may include a microprocessor, a microcontroller, a reduced instruction set computer (RISC) processor, etc.

Further, in operation, the data generator 814 may generate outgoing data for transmission to another communications device via the baseband unit 810 which processes the outgoing data into a baseband signal for transmission, the baseband-to-RF transmitter portion 816 which converts the baseband signal into an RF signal, the RF transmitter 818 which conditions the RF signal for transmission via the wireless medium, the Tx/Rx isolation device 804 which routes the RF signal to the antenna 802 while isolating the input of the RF receiver 806, and the antenna 802 which radiates the RF signal into the wireless medium. The data generator 814 may be a sensor or other type of data generator. For example, the data generator 818 may include a sensor or any other type of data generator.

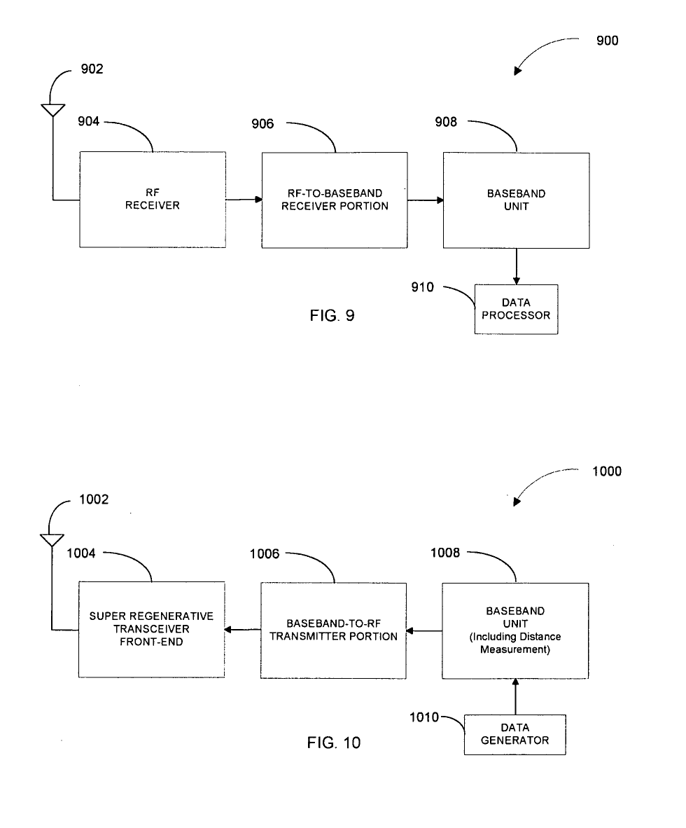

FIG. 9 illustrates a block diagram of an exemplary communications device 900 in accordance with another aspect of the disclosure. The communications device 900 may be particularly suited for receiving data from other communications devices. The communications device 900 comprises an antenna 902, an RF receiver 904, an RF-to-baseband receiver portion 906, a baseband unit 908, and a data processor 910. The antenna 902 may be configured as any one of the antennas previously discussed.

In operation, the data processor 912 may receive data from another communications device via the antenna 902 which picks up the RF signal from the communications device, the RF receiver 904 which amplifies the received signal, the RF-to-baseband receiver portion 906 which converts the RF signal into a baseband signal, and the baseband unit 908 which processes the baseband signal to determine the received data. The data processor 910 may then perform one or more defined operations based on the received data. For example, the data processor 910 may include a microprocessor, a microcontroller, a reduced instruction set computer (RISC), etc.

FIG. 10 illustrates a block diagram of an exemplary communications device 1000 in accordance with another aspect of the disclosure. The communications device 1000 may be particularly suited for sending data to other communications devices. The communications device 1000 comprises an antenna 1002, an RF transmitter 1004, a baseband-to-RF transmitter portion 1006, a baseband unit 1008, and a data generator 1010. The antenna 1002 may be configured as any one of the antennas previously discussed.

In operation, the data generator 1010 may generate outgoing data for transmission to another communications device via the baseband unit 1008 which processes the outgoing data into a baseband signal for transmission, the baseband-to-RF transmitter portion 1006 which converts the baseband signal into an RF signal, the transmitter 1004 which conditions the RF signal for transmission via the wireless medium, and the antenna 1002 which radiates the RF signal into the wireless medium. The data generator 1010 may be a sensor or other type of data generator.

In any of the above communications devices 800, 900, and 1000, a user interface may be employed to provide visual, audible or thermal indication associated with the received or outgoing data. As examples, a user interface may include a display, one or more light emitting diodes (LED), audio transducers such as a microphone or one or more speakers, and others. Any of the above communications devices 800, 900, and 1000 may be employed in any type of applications, such as in a medical device, shoe, watch, robotic or mechanical device, a headset, a global positioning system (GPS) device, and others.

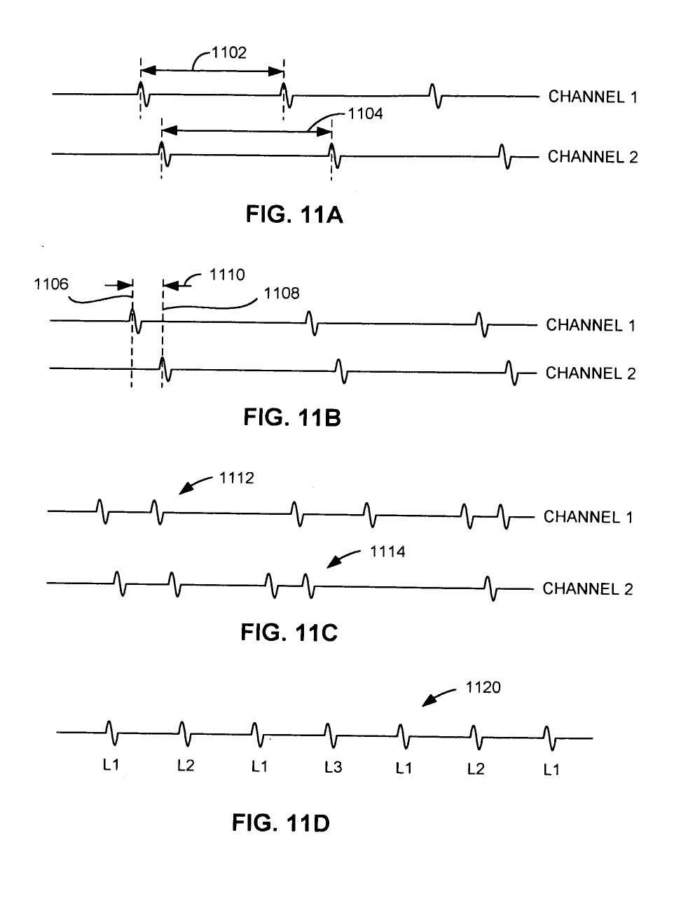

FIG. 11A illustrates different channels (channels 1 and 2) defined with different pulse repetition frequencies (PRF) as an example of a PDMA modulation. Specifically, pulses for channel 1 have a pulse repetition frequency (PRF) corresponding to a pulse-to-pulse delay period 1102. Conversely, pulses for channel 2 have a pulse repetition frequency (PRF) corresponding to a pulse-to-pulse delay period 1104. This technique may thus be used to define pseudo-orthogonal channels with a relatively low likelihood of pulse collisions between the two channels. In particular, a low likelihood of pulse collisions may be achieved through the use of a low duty cycle for the pulses. For example, through appropriate selection of the pulse repetition frequencies (PRF), substantially all pulses for a given channel may be transmitted at different times than pulses for any other channel.

The pulse repetition frequency (PRF) defined for a given channel may depend on the data rate or rates supported by that channel. For example, a channel supporting very low data rates (e.g., on the order of a few kilobits per second or Kbps) may employ a corresponding low pulse repetition frequency (PRF). Conversely, a channel supporting relatively high data rates (e.g., on the order of a several megabits per second or Mbps) may employ a correspondingly higher pulse repetition frequency (PRF).

FIG. 11B illustrates different channels (channels 1 and 2) defined with different pulse positions or offsets as an example of a PDMA modulation. Pulses for channel 1 are generated at a point in time as represented by line 1106 in accordance with a first pulse offset (e.g., with respect to a given point in time, not shown). Conversely, pulses for channel 2 are generated at a point in time as represented by line 1108 in accordance with a second pulse offset. Given the pulse offset difference between the pulses (as represented by the arrows 1110), this technique may be used to reduce the likelihood of pulse collisions between the two channels. Depending on any other signaling parameters that are defined for the channels (e.g., as discussed herein) and the precision of the timing between the devices (e.g., relative clock drift), the use of different pulse offsets may be used to provide orthogonal or pseudo-orthogonal channels.

FIG. 11C illustrates different channels (channels 1 and 2) defined with different timing hopping sequences. For example, pulses 1112 for channel 1 may be generated at times in accordance with one time hopping sequence while pulses 1114 for channel 2 may be generated at times in accordance with another time hopping sequence. Depending on the specific sequences used and the precision of the timing between the devices, this technique may be used to provide orthogonal or pseudo-orthogonal channels. For example, the time hopped pulse positions may not be periodic to reduce the possibility of repeat pulse collisions from neighboring channels.

FIG. 11D illustrates different channels defined with different time slots as an example of a PDM modulation. Pulses for channel L1 are generated at particular time instances. Similarly, pulses for channel L2 are generated at other time instances. In the same manner, pulse for channel L3 are generated at still other time instances. Generally, the time instances pertaining to the different channels do not coincide or may be orthogonal to reduce or eliminate interference between the various channels.

It should be appreciated that other techniques may be used to define channels in accordance with a pulse modulation schemes. For example, a channel may be defined based on different spreading pseudo-random number sequences, or some other suitable parameter or parameters. Moreover, a channel may be defined based on a combination of two or more parameters.

FIG. 12 illustrates a block diagram of various ultra-wide band (UWB) communications devices communicating with each other via various channels in accordance with another aspect of the disclosure. For example, UWB device 1 1202 is communicating with UWB device 2 1204 via two concurrent UWB channels 1 and 2. UWB device 1202 is communicating with UWB device 3 1206 via a single channel 3. And, UWB device 3 1206 is, in turn, communicating with UWB device 4 1208 via a single channel 4. Other configurations are possible. The communications devices may be used for many different applications, and may be implemented, for example, in a headset, microphone, biometric sensor, heart rate monitor, pedometer, EKG device, watch, shoe, remote control, switch, tire pressure monitor, or other communications devices.

Any of the above aspects of the disclosure may be implemented in many different devices. For example, in addition to medical applications as discussed above, the aspects of the disclosure may be applied to health and fitness applications. Additionally, the aspects of the disclosure may be implemented in shoes for different types of applications. There are other multitude of applications that may incorporate any aspect of the disclosure as described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. An apparatus for wireless communications, comprising:
a first radiating element; and
a second radiating element that substantially surrounds the first radiating element to define a gap therebetween.

2. The apparatus of claim 1, wherein the first radiating element is electromagnetically coupled to and electrically insulated from the second radiating element.

3. The apparatus of claim 2, further comprising a third radiating element that is electromagnetically coupled to the first and second radiating elements, wherein the third radiating element is electrically coupled to the second radiating element and electrically insulated from the first radiating element.

4. The apparatus of claim 3, wherein at least one characteristic feature of the second radiating element is substantially the same as at least one characteristic feature of the third radiating element.

5. The apparatus of claim 3, wherein at least one characteristic feature of the second radiating element extends substantially perpendicular to at least one characteristic feature of the third radiating element.

6. The apparatus of claim 3, wherein at least one characteristic feature of the second radiating element extends substantially parallel to at least one characteristic feature of the third radiating element.

7. The apparatus of claim 2, wherein at least one characteristic feature of the second or third radiating element comprises a direction, a length, a width, a height, an area, or a volume.

8. The apparatus of claim 1, further comprising a dielectric substrate, wherein the first and second radiating elements are formed as metallization layers on one or more sides of the dielectric substrate.

9. The apparatus of claim 8, wherein the dielectric substrate includes one or more chamfered corners.

10. The apparatus of claim 1, further comprising a feed electrically coupled to the first radiating element and electrically insulated from the second radiating element.

11. The apparatus of claim 10, wherein the feed forms part of or is electrically coupled to a center conductor of a coaxial transmission line.

12. The apparatus of claim 10, wherein the feed is electrically coupled to a printed circuit board.

13. The apparatus of claim 1, wherein the first and second radiating elements are adapted to transmit or receive a signal within a defined ultra-wide band channel that has a fractional bandwidth on the order of 20% or more, has a bandwidth on the order of 500 MHz or more, or has a fractional bandwidth on the order of 20% or more and has a bandwidth on the order of 500 MHz or more.

14. A method for wireless communications, comprising electromagnetically coupling a first radiating element to a second radiating element, wherein the second radiating element substantially surrounds the first radiating element to define a gap therebetween.

15. The method of claim 14, further comprising configuring the first radiating element to be electrically insulated from the second radiating element.

16. The method of claim 15, further comprising:
configuring a third radiating element to be electromagnetically coupled to the first and second radiating elements; and
configuring the third radiating element to be electrically coupled to the second radiating element and electrically insulated from the first radiating element.

17. The method of claim 16, further comprising configuring at least one characteristic feature of the second radiating element to be substantially the same as at least one characteristic feature of the third radiating element.

18. The method of claim 16, further comprising configuring at least one characteristic feature of the second radiating element to extend substantially perpendicular to at least one characteristic feature of the third radiating element.

19. The method of claim 16, further comprising configuring at least one characteristic feature of the second radiating element to extend substantially parallel to at least one characteristic feature of the third radiating element.

20. The method of claim 16, further comprising configuring at least one characteristic feature of the second or third radiating element to be a direction, a length, a width, a height, an area or a volume.

21. The method of claim 14, further comprising forming the first and second radiating elements as metallization layers on one or more sides of a dielectric substrate.

22. The method of claim 21, further comprising configuring the dielectric substrate to include one or more chamfered corners.

23. The method of claim 14, further comprising providing a feed coupled to the first radiating element and electrically insulated from the second radiating element.

24. The method of claim 23, further comprising configuring the feed to form part of or electrically coupled to a center conductor of a coaxial transmission line.

25. The method of claim 23, further comprising configuring the feed to be electrically coupled to a printed circuit board.

26. The method of claim 14, further comprising configuring the first and second radiating elements to transmit or receive a signal within a defined ultra-wide band channel that has a fractional bandwidth on the order of 20% or more, has a bandwidth on the order of 500 MHz or more, or has a fractional bandwidth on the order of 20% or more and has a bandwidth on the order of 500 MHz or more.

27. An apparatus for wireless communications, comprising:
a first means for radiating an electromagnetic signal; and
a second means for radiating the electromagnetic signal, wherein the second radiating means that substantially surrounds the first radiating means to define a gap therebetween.

28. The apparatus of claim 27, wherein the first radiating means is electromagnetically coupled to and electrically insulated from the second radiating means.

29. The apparatus of claim 28, further comprising a third means for radiating the electromagnetic signal, wherein the third radiating means is electromagnetically coupled to the first and second radiating means, and further wherein the third radiating means is electrically coupled to the second radiating means and electrically insulated from the first radiating means.

30. The apparatus of claim 29, wherein at least one characteristic feature of the second radiating means is substantially the same as at least one characteristic feature of the third radiating means.

31. The apparatus of claim 29, wherein at least one characteristic feature of the second radiating means extends substantially perpendicular to at least one characteristic feature of the third radiating means.

32. The apparatus of claim 29, wherein at least one characteristic feature of the second radiating means extends substantially parallel to at least one characteristic feature of the third radiating means.

33. The apparatus of claim 29, wherein at least one characteristic feature of the first or second radiating means comprises a direction, a length, a width, a height, an area, or a volume.

34. The apparatus of claim 27, further comprising a dielectric substrate, wherein the first and second radiating means are formed as metallization layers on one or more sides of the dielectric substrate.

35. The apparatus of claim 34, wherein the dielectric substrate includes one or more chamfered corners.

36. The apparatus of claim 27, further comprising a means for feeding the electromagnetic signal to or from the first radiating means, wherein the feeding means is electrically insulated from the second radiating means.

37. The apparatus of claim 36, wherein the feeding means forms part of or is electrically coupled to a center conductor of a coaxial transmission line.

38. The apparatus of claim 36, wherein the feeding means is electrically coupled to a printed circuit board.

39. The apparatus of claim 27, wherein the first and second radiating means are adapted to transmit or receive a signal within a defined ultra-wide band channel that has a fractional bandwidth on the order of 20% or more, has a bandwidth on the order of 500 MHz or more, or has a fractional bandwidth on the order of 20% or more and has a bandwidth on the order of 500 MHz or more.

40. A headset, comprising:
an antenna comprising:
a first radiating element; and
a second radiating element that substantially surrounds the first radiating element to define a gap therebetween;
a receiver adapted to receive an incoming signal including audio data from a remote apparatus via the antenna; and
a transducer adapted to generate an audio output from the audio data.

41. A watch, comprising:
an antenna comprising:
a first radiating element; and
a second radiating element that substantially surrounds the first radiating element to define a gap therebetween;
a receiver adapted to receive an incoming signal including data from a remote apparatus via the antenna; and
a user interface adapted to produce an indication based on the received data.

42. A sensing device for wireless communications, comprising:
an antenna comprising:
a first radiating element; and
a second radiating element that substantially surrounds the first radiating element to define a gap therebetween;
a sensor adapted to generate sensed data; and
a transmitter adapted to transmit a signal including the sensed data to a remote apparatus via the antenna.
